(19) United States
(12) Patent Application Publication
(10) Pub. No.: US 2009/0298951 A1
(43) Pub. Date: Dec. 3, 2009

(54) Nontoxic Biocidal Composition And Method Thereof

(76) Inventor: Larry W. Van Etten, Rahramp, NV (US)

Correspondence Address: LAW OFFICE OF TRACY P. JONG, 2775 BUFFALO ROAD, SUITE 3, ROCHESTER, NY, 14624, US

(21) Appl. No.: 12/475,329

(22) Filed: May 29, 2009

Related U.S. Application Data
(60) Provisional application No. 61/057,422, filed on May 30, 2008.

(51) Int. Cl. A01N 27/00; A01P 1/00; A01P 3/00

(52) U.S. Cl. 514/762

(57) ABSTRACT

This invention discloses biocidal compositions and methods and more particularly, a novel nontoxic biocide and biostat composition and method for elimination and inhibition of gram negative bacteria (microorganism), viral, and/or fungal growth, especially molds. In one formulation, the novel biocidal composition is formed from equal amounts of potassium sorbate, lecithin, cellulose, and wax in a suspension with distilled mineralized water, preferably distilled mineralized water in combination with about 15% catalyst activated fluorine and chlorine free water. Using cellulose as a carrier for a wax to be ingested by a microorganism, fungal spore or virus is effective as a biocide because the ingested wax encapsulates the microorganism, fungal spore or virus, thereby effectively suffocating it.

### CROSS REFERENCE TO RELATED APPLICATIONS AND PRIORITY CLAIM

This application claims the benefit of U.S. Ser. No. 61/057,422 filed by Larry VanEtten on May 30, 2008 entitled “Nontoxic Biocide and Biostat, Method and Preparation Thereof.”

### BACKGROUND OF THE INVENTION

1. Field of the Invention

This invention relates to biocide and biostat compositions and methods and more particularly, to a novel nontoxic biocidal composition and method for elimination and inhibition of gram negative bacteria, viral, and/or fungal growth, especially molds.

2. Description of Related Art

Biocides and biostats are used to control the growth of harmful biological species. Many are known in the prior art, but recent attention has been focused on biocides that are particularly effective against molds. Mold, a member of the fungi family, can cause illness and death, especially in infants, the elderly, diabetics, transplant patients, chemotherapy and cancer patients, or persons that are immuno compromised. Mold can trigger allergic reactions and asthma, memory impairment, migraines, sick building syndrome, dizziness, nosebleeds, or pulmonary hemosiderosis. The estimated annual cost to the economy for sick building syndrome (SBS) alone is in the billions of dollars according to the EPA. The liability for mold illnesses and remediation is financially devastating to many industries.

There are many known biocides known in the prior art for removing and eliminating fungi, in particular molds and/or mildews. To control deterioration or degradation caused by fungi and other microorganisms, various microbicides and fungicides have been used. Workers in the trade have continued to seek improved biocides and fungicides that have low toxicity, are cost effective and are capable of exhibiting a prolonged biocidal/fungicidal effect against a wide variety of microorganisms and fungi. Many of these compositions require gloves and ventilation during use. Most are poisonous if ingested.

Fungicides, also known as mold removers and inhibitors, of the prior art incorporate active ingredients such as calcined clay, sodium chlorite, oxychlorine compounds, dimethyl didecyl ammonium chloride, sodium percarbonate, inorganic salts, quaternary ammonium compounds, benzyl-1-C12-18 alkyl dimethyl, stabilized chloride, dioxide, boric acid and the aqueous oxidant family. Compositions such as these contain warnings about health hazards ranging from mild respiratory tract and lung irritations to severe damage to mucous membranes, chemical pneumonia or permanent lung damage; mild to severe irritation to skin, with prolonged contact causing dermatitis and chemical burns; ingestion irritation to mouth, throat, and stomach; nausea, vomiting, pain, and diarrhea; and eye irritation and even permanent eye damage.

The drawbacks of these formulations are their toxicity both during and following use. These prior art formulations emit odors, fumes or other off-gassing and leave a deposit of chemical residue. Off gassing can linger for months after application.

With respect to cattle feed, contaminated grains are typically controlled by direct flaming, anhydrous ammonia and/or sodium bicarbonate. However, according to one Department of Agriculture, “none of these techniques work on mycotoxin-contaminated forages.” The suggested strategy when preventative techniques have failed is simply to dilute contaminate feedstuffs with clean feeds to minimize livestock problems. For obvious reasons, this is not a complete or acceptable solution to the problem of contaminated feed stocks.

Many biostats in the form of disinfectants, antifungals, antivirals and antibacterials are used in treating animals, humans, and their environments. However, none is known that has such broad ranging biocidal effects in a composition that is so nontoxic it is actually digestible.

Thus it is desirable to provide a nontoxic biocide and biostat composition and method that eliminates one or more of the drawbacks and limitations of the prior art.

### SUMMARY OF THE INVENTION

In accordance with this invention, there is provided an improved biocidal composition that overcomes the limitations of the prior art by using a unique and previously unknown composition comprising 0.00663 weight percent of a positive charge enhancing additive, 0.00663 weight percent of a carrier, and 0.00663 weight percent of an active biocidal component wherein a positive charge of the positive charge enhancing additive in combination with the carrier facilitates entry of the active biocidal component into a cellular wall of a fungal spore, virus and microorganism. In one aspect, the biocidal composition is in the form of a suspension comprising distilled water and a biocidally effective mixture formed of equal parts of potassium sorbate, lecithin, cellulose, and wax.

There is provided a mold inhibiting composition comprising a suspension formed of cellulose, distilled water and microdispersed wax. The cellulose is the carrier for the wax which is lethal to the mold because it encapsulates the fungal spore and blocks its air and/or digestive pathways. An emulsifier helps keep the wax in suspension and a positive charge enhancing additive works in combination with the cellulose to facilitate entry of the wax into the cellular wall of the fungal spore. Potassium sorbate works particularly well as the positive charge enhancing additive and lecithin works well as the emulsifier.

In accordance with this invention, there is provided a biocidal composition that overcomes the limitations of the prior art by using a unique and previously unknown composition comprising 0.00663 weight percent of positive charge carrier, 0.00663 weight percent of carrier, and 0.00663 weight percent of active biocidal component. In one aspect, the biocidal composition is a suspension formed with distilled water and 0.00663 weight percent of an emulsifier to keep the microdispersed wax suspended in the water. In an especially preferred embodiment, the distilled mineralized water is a solution of distilled mineralized water and a catalyst activated water (CAW). Ratios of 85:15 distilled mineralized water: catalyst activated water are effective and are more economical that 100% CAW.

In a preferred embodiment, the novel biocide and biostat composition comprises 0.00663 weight percent of potassium sorbate, 0.00663 weight percent of lecithin, 0.00663 weight percent of cellulose, and 0.00663 weight percent of wax. In a preferred embodiment the novel biocide and biostat composition further comprises catalyst activated fluorine and chlorine free water (also known as structured water). In another embodiment, catalyst activated water in gel format is used.

There is also provided a method of eliminating and/or inhibiting fungi, and especially molds, by treatment with a composition comprising a fungicidally effective amount of potassium sorbate, lecithin, cellulose, and wax.

There is also provided a method of eliminating and/or inhibiting pathogenic microbes, and especially gram negative bacteria, by treatment with a composition comprising an antibacterially effective amount of potassium sorbate, lecithin, cellulose, and wax.

There is also provided a method of eliminating and/or inhibiting pathogenic viruses by treatment with a composition comprising a virucidally (or biocidally) effective amount of potassium sorbate, lecithin, cellulose, and wax.

It is an object of this invention to provide a nontoxic fungicide.

It is an object of this invention to provide a nontoxic microbicide.

It is an object of this invention to provide a nontoxic biocide.

It is an object of this invention to provide a nontoxic biostat.

It is a further object of the present invention to provide a fungicide and microbicide that may be used to inhibit fungi, especially molds.

It is a further object of the present invention to provide a biocide that is versatile and readily adaptable to use on a wide range of materials and substrates.

It is a further object of the present invention to provide a biostat that is versatile and readily adaptable to use on a wide range of materials and substrates.

It is a further object of the present invention to provide a universally safe and effective biocide and/or biostat that can be used in any environment and on any material.

It is a further object of the present invention to provide a method of elimination and/or inhibiting gram negative bacteria, viral, and/or fungal growth, especially molds, with a composition comprising potassium sorbate, lecithin, cellulose, and beeswax.

Whereas there may be many embodiments of the present invention, each embodiment may meet one or more of the foregoing recited objects in any combination. It is not intended that each embodiment will necessarily meet each objective.

Thus, having broadly outlined the more important features of the present invention in order that the detailed description thereof may be better understood, and that the present contribution to the art may be better appreciated, there are, of course, additional features of the present invention that will be described herein and will form a part of the subject matter of the claims appended to this specification. In this respect, before explaining at least one embodiment of the invention in detail, it is to be understood that the invention is not limited in its application to the details of composition and the arrangements of the process steps set forth in the following description. The present invention is capable of other embodiments and of being practiced and carried out in various ways. Also it is to be understood that the phraseology and terminology employed herein are for the purpose of description and should not be regarded as limiting.

### PARTICULAR ADVANTAGES OF THE PRESENT INVENTION

The biocidal composition and method provides a universally safe and effective biocide and/or biostat that can be used in any environment and on any material. It is nontoxic and even safe for human consumption, yet potently effective at eliminating and inhibiting the growth of gram negative bacteria, viruses, molds and fungi.

### DETAILED DESCRIPTION OF A PREFERRED EMBODIMENT OF THE INVENTION

The present invention relates to compositions and methods for controlling the growth of microorganisms on a variety of mediums, substrates and in aqueous systems. The present invention is a biocidal and biostat composition comprising effective amounts of active compounds potassium sorbate, lecithin, cellulose, and wax. In its preferred embodiment, the active compounds are in a suspension with distilled water such that the wax is microdispersed in the suspension. The composition of the present invention is non-toxic, nonhazardous and even safe for human consumption. The composition may be applied before or after infection by the microbes (e.g. gram negative bacteria, mold, mildew or fungi).

The composition is safe for humans, animals, birds and aquatic life. It is 100% all natural green technology and exempt from EPA regulations as a GRAS composition. The effectiveness of the biostats in the composition continue as long as the composition remains positively charged and/or it becomes saturated with fungi/mold or microbes. As will be appreciated by those skilled in the art, frequency of treatment will correspond to the material, environment (e.g. temperature, humidity, oxygen, light) and fungi/microbe sought to be eliminated. By way of illustration, in the case of a residential home in the Southern United States, it should be treated annually.

As used in this specification, biocide means a substance that kills one or more, and preferably all, microbial life forms when introduced in sufficient concentration and duration. Specifically, a biocide according to the present invention kills gram negative bacteria, mold, mildew and fungi. A fungus is a eukaryotic organism having a cell but no chlorophyll. They may be unicellular or multicellular. The fungi family includes molds. Mildew is a form of mold.

As used in this specification, antimicrobial means a substance that inhibits one or more microbial life forms, and in particular is effective at inhibiting vegetative disease causing organisms, when introduced in sufficient concentration and duration. As used in this specification, antifungal means a substance that inhibits one or more fungi (including mold) life forms, and in particular is effective at inhibiting vegetative disease causing fungi, molds and myocytes, when introduced in sufficient concentration and duration.

As used in this specification, biostat means a substance that inhibits one or more life forms when introduced in sufficient concentration and duration. By way of illustration, but not limitation, disinfectants are commonly used biostat compositions that are effective at inhibiting vegetative disease causing organisms and molds. Many disinfectants additionally function as biocides.

### Novel Composition

In accordance with this invention, there is provided an improved biocidal composition that overcomes the limitations of the prior art by using a unique and previously unknown composition comprising 0.00663 weight percent of a positive charge enhancing additive, 0.00663 weight percent of a carrier, and 0.00663 weight percent of an active biocidal component wherein a positive charge of the positive charge enhancing additive in combination with the carrier facilitates entry of the active biocidal component into a cellular wall of a fungal spore, virus and microorganism. In one aspect, the biocidal composition is in the form of a suspension comprising distilled water and a biocidally effective mixture formed of equal parts of potassium sorbate, lecithin, cellulose, and wax.

There is provided a mold inhibiting composition comprising a suspension formed of cellulose, distilled water and microdispersed wax. The cellulose is the carrier for the wax which is lethal to the mold because it encapsulates the fungal spore and blocks its air and/or digestive pathways. An emulsifier helps keep the wax in suspension and a positive charge enhancing additive works in combination with the cellulose to facilitate entry of the wax into the cellular wall of the fungal spore. Potassium sorbate works particularly well as the positive charge enhancing additive and lecithin works well as the emulsifier. A mold inhibiting composition comprising a suspension formed of equal parts of potassium sorbate, lecithin, cellulose, and wax is effective and nontoxic.

In accordance with this invention, there is provided a biocidal composition that overcomes the limitations of the prior art by using a unique and previously unknown composition comprising 0.00663 weight percent of positive charge carrier, 0.00663 weight percent of carrier, and 0.00663 weight percent of active biocidal component. In one aspect, the biocidal composition is a suspension formed with distilled water and 0.00663 weight percent of an emulsifier to keep the microdispersed wax suspended in the water. In an especially preferred embodiment, the distilled mineralized water is a solution of distilled mineralized water and a catalyst activated water (CAW). Ratios of 85:15 distilled mineralized water: catalyst activated water are effective and are more economical that 100% CAW.

In a preferred embodiment the novel biocidal and/or biostat composition comprising 0.00663 weight percent of potassium sorbate, 0.00663 weight percent of lecithin, 0.00663 weight percent of cellulose, and 0.00663 weight percent of wax. In a preferred embodiment the novel biocidal and/or biostat composition further comprises catalyst activated fluorine and chlorine free water.

The active compounds are preferably mixed with catalyst activated water (CAW) such that the weight ratio of potassium sorbate to CAW is 0.0441% or 0.000441:1 (potassium sorbate:CAW); the weight ratio of lecithin to CAW is 0.0441% or 0.000441:1 (lecithin:CAW); the weight ratio of cellulose to CAW is 0.0441% or 0.000441:1 (cellulose:CAW); and the weight ratio of wax to CAW is 0.0441% or 0.000441:1 (wax:CAW) (weights at 68 degrees Fahrenheit). This concentrated suspension can be diluted with distilled mineralized water to form a total of one gallon of product.

The active compounds are employed in a purity of from about 80% to about 100%, preferably from about 95% to 100%. In a preferred embodiment the novel biocidal and/or biostat composition comprises from about 0.245 to about 0.26, preferably about 0.25 grams of potassium sorbate; from about 0.245 to about 0.26, preferably about 0.25 grams of lecithin; from about 0.245 to about 0.26, preferably about 0.25 grams of cellulose; and from about 0.245 to about 0.26, preferably about 0.25 grams of wax per gallon of solution. The active compounds are in a ratio of from about 0.0002652:1 (active compounds:water) with water. Preferably, the water comprises a solution of 15% catalyst activated water such as chlorine and fluorine free mineralized water and 85% distilled mineralized water. Most preferably, catalyst activated water such as Willard Water from South Dakota is used with the composition of the present invention. In one preferred embodiment, the boiling point of the composition is 100 degrees Celsius and the specific gravity is 1.2 (water=1). The composition is fully soluble in water, is odorless and appears as an opaque liquid suspension.

There is also provided a method of eliminating and/or inhibiting gram negative bacteria, viral, and/or fungal growth, especially molds, by treatment with a composition comprising 0.00663 weight percent of potassium sorbate, 0.00663 weight percent of lecithin, 0.00663 weight percent of cellulose, and 0.00663 weight percent of wax. In one aspect, the composition is prepared according to the novel process of the present invention.

The novel composition acts as a biocide and biostat by using wax to encapsulate the microorganism, thereby effectively suffocating the fungal spore, virus or microbe. Gram-negative bacteria, mold, fungus, and viruses share the common biological characteristic of being attracted to a positive charge, and in particular, a positive ionic charge of potassium sorbate. By combining the biocidally effective components with the food components of the microbes/fungi, the biocide can be ingested in an amount effective to act as a biocide or biostat.

Molds require one or more organic nutrients. Because molds must absorb or transport their nutrients through the cell surface, they compete with bacteria for organic nutrients. Many molds have an advantage over the bacteria in this competition, because they can secrete digestive extra cellular enzymes such as cellulases. Thus they can degrade an otherwise insoluble organic substrate into its smaller soluble subunits, which they then absorb and use as sources of carbon and energy. This enables the molds to use carbon sources, including cellulose, that are unavailable to most other microorganisms. Thus, the use of cellulose as a carrier is advantageous for the treatment of molds in particular.

The novel biocidal composition attaches to the effected surfaces of gram negative bacteria, fungi, mold or virus and kill it. The charge of the potassium sorbate attracts the gram negative bacteria, fungi, mold or virus and facilitates its entry into the digestive canals quickly. The novel biocidal composition effectively suffocates the microorganism by blocking the air/digestive action pathways. Gram-negative bacteria can not burp, flactuate, or otherwise clear its own digestive canals. Since the composition acts much more quickly than the microorganism can naturally digest, and it blocks the air/digestive action pathways, and thus immediately renders the microorganism a lethal dose. The effectiveness of the composition is in part due to its active mechanism's natural harmony with the workings of the microorganisms. Specifically, the charged potassium sorbate is attracted to the opposing charge of the microorganism permitting entry of the biocidal components into the microorganism's cellular wall, and thereafter, the wax blocks the pathway and encapsulates the spore/molecule.

The active compound potassium sorbate functions as a charge enhancing additive, specifically a positive charge. Potassium sorbate is also known as 2,4-hexadienoic acid potassium salt {potassium sorbate [K(CH₃CH═CHCH′CHCO₂)]. The molecular formula of potassium sorbate is C₆H₇O₂K and its systematic name is potassium (E,E)-hexa-2,4-dienoate. It has a molecular weight of 150.22 g/mol. It is very soluble in water (58.2% at 20° C.). It is prepared by the reaction of sorbic acid with potassium hydroxide.

While potassium sorbate has been known for its antimicrobial and antifungal properties for food and cosmetics preservatives, when used in accordance to the present invention, it has an unexpected, intriguing nature on account of its ionic properties. The positively charged potassium sorbate seeks out the opposite charge of the microorganism and draws the gram negative bacteria, fungi, mold or virus to it, or conversely, is drawn to the gram negative bacteria, fungi, mold or virus. The natural antimicrobial and antifungal properties of potassium sorbate enhance the overall efficacy of the composition.

Potassium sorbate is considered to be safe because of its long term safety record and non-toxic profile. Potassium sorbate is non-irritating and non-sensitizing. Allergic reactions are rare and it is well tolerated when administered internally.

The active compound lecithin functions as a natural emulsifier that allows penetration of the potassium sorbate. It may also function as a surfactant and dispersant. Preferably, lecithin is extracted from soybean plants (SID: 48414465). Other forms of lecithin tend to form a ‘glob’ even when the temperature during mixing is held at 100 degrees Celsius for an extended period of time (more than 30 seconds).

The active compound cellulose functions as a carrier of the charged material and wax. Once charged, the cellulose will not alter the potassium sorbate or its positive charge. It assists in holding the charged material at its charge state during delivery to the microorganism.

The active compound wax functions to encapsulate and suffocate the gram negative bacteria, fungi, mold or virus spore or molecule. Preferably, the wax comprises a western wax from cactus. New Mexico wax has been the best for the following characteristics: melting, delivery, encapsulation, blending, mixing, non-coagulating in the container and body/surface, and general efficacy.

In another embodiment, the wax comprises beeswax. Beeswax, like honey, contains one or more sylfhydrils which are natural antibodies. Beeswax also contains one or more capsaicin (capsinoids) compounds, some of which are natural antimicrobials. These enhance the biocidal properties of the composition.

The active substance compositions thus obtainable can be used directly as such or after diluting. In addition, the compositions according to the present invention can also comprise conventional additives such as, for example, viscosity-modifying additives, anti-foam agents, anti-freeze agents, dispersants, emulsifiers, surfactants, binders, waxes and the like. It is important that the charge of the composition is not modified.

The composition of the present invention can be formulated in the form of directly sprayable solutions, powders and suspensions or in the form of highly concentrated aqueous, oily or other suspensions, dispersions, emulsions, oil dispersions, pastes, dusts, materials for broadcasting or granules, and applied for spraying, atomizing, dusting, broadcasting or watering. The form depends on the intended purpose. In any case, it should as fine and uniform as possible a distribution of the mixture according to the present invention. The formulations are prepared in a manner known in the art, such as, for example, using appropriate carriers and/or solvents, and inert additives such as emulsifiers, surfactants, dispersants and the like.

The compositions are applied by treating the harmful mold, gram negative bacteria, virus, mildew or fungi, their habitat, areas, materials or spaces to be kept free from them with a biocidally effective amount of the mixture. Depending on the kind of effect desired, the application rates of the composition may be enough to saturate the target growth or to lightly cover the surface with a fine mist or spray. In a preferred method of use, the composition is prepared as a suspension according to the novel process described herein and is sprayed onto a moldy or effected surface and allowed to penetrate for three to five seconds.

### Treatment of Molds and Myocytes

The composition is effective against the following molds and/or the mycotoxins they produce: Aspergillus, Cladosporium, Penicillium, Stachybotrys, and Trichoderma. The composition is effective against the following fungi: Paracoccidioides brasiliensis, Candida albicans, Histoplasma, Cryptococcus, B. dermatitidis, Coccidioides immitis, and Paracoccidioides brasiliensis. Exposure routes include skin, inhalation, and ingestion.

### Novel Process for Manufacturing a Novel Biocidal Composition

Preferably, the composition of the present invention is prepared by a process comprising the steps of:

Preparing a solution of 15% catalyst activated water and distilled mineralized water;

Heating the solution to about 100 degrees Celsius;

Adding 0.25 grams wax;

Mixing the solution at a speed of from about 1000 rpm to about 1250 rpm, preferably from about 1150 rpm to about 1250 rpm, while maintaining a temperature of from about 80 to about 120 degrees Celsius, preferably from about 95 to about 100 degrees Celsius; for a period of from about 30 to about 60 seconds;

Adding 0.25 grams potassium sorbate;

Mixing the solution at a speed of from about 1000 rpm to about 1250 rpm, preferably from about 1150 rpm to about 1250 rpm, while maintaining a temperature of from about 80 to about 120 degrees Celsius, preferably from about 95 to about 100 degrees Celsius; for a period of from about 30 to about 60 seconds;

Adding 0.25 grams cellulose;

Mixing the solution at a speed of from about 1000 rpm to about 1250 rpm preferably from about 1150 rpm to about 1250 rpm while maintaining a temperature of from about 80 to about 120 degrees Celsius preferably from about 95 to about 100 degrees Celsius; for a period of from about 5 to about 60 seconds;

Adding 0.25 grams lecithin;

Mixing the solution at a speed of from about 1000 rpm to about 1250 rpm preferably from about 1150 rpm to about 1250 rpm while maintaining a temperature of from about 80 to about 120 degrees Celsius preferably from about 95 to about 100 degrees Celsius; for a period of from about 5 to about 60 seconds to create a suspension;

Filtering the suspension by a filter greater than 5 microns; and

Cooling the suspension to ambient temperature.

The solution may be made in greater or smaller quantities by a batch process with appropriate adjustments to the ingredients to maintain the desired ratios directly proportionate to the batch size.

Preferably, the equipment used throughout the mixing and blending process is formed of materials that will not carry an electronic charge or current of any kind on the surface of the vessels or with its materials. It is important that during the process, no charge, irrespective of its significance in size or polarity, may be added or taken from the batch.

### Storage, Spoliation and Recharging

Preferably, the biocidal composition is stored in bottle or container formed of a material that will not carry an electronic charge or current of any kind on the surface of the vessels or with its materials. Preferably, the lid is sealed at all times except during use, and especially during a storm to prevent changes in polarity or charge of the composition.

Preferably, the composition is not frozen and measures to prevent freezing are undertaken.

Should the composition lose its charge and effectively become spoiled against its biocidal properties, it can be recharged.

### Agricultural Formulations

In one aspect of the present invention, an agricultural formulation may be prepared for application to animal or human food sources at any point in the lifecycle from seeds, growing plants, harvested plants in storage, or food production ingredients, intermediate or products. Agricultural formulations suitable for use in the present invention include compositions wherein the active ingredients are contained in an effective amount to achieve its intended purpose. More specifically, a biologically effective amount means an amount effective to prevent development of or to alleviate the existing pathogenic fungi or gram negative microbe of the subject food source being treated. Determination of the effective amounts is well within the capability of those skilled in the art, especially in light of the detailed disclosure provided herein. The amount of formulation administered will be dependent upon the plant variety being treated, the stage of lifecycle of the plant being treated, the manner of administration and the judgment of the personalizing botanist.

In addition to a solution, the novel biocidal composition may be prepared as a powder, material for broadcasting and/or dust according to conventional techniques. Granules (for example coated granules, impregnated granules or homogenous granules) can also be prepared according to convention techniques by binding the active compounds to a solid carrier.

The agricultural formulations of the present invention may be manufactured in a manner that is itself known, e.g., by means of conventional mixing, dissolving, granulating, dragee-making, levigating, emulsifying, encapsulating, entrapping or lyophilizing processes.

Agricultural formulations for use in accordance with the present invention thus may be formulated in a conventional manner using one or more physiologically acceptable carriers comprising excipients and auxiliaries which facilitate processing of the compositions compounds into preparation which can be used agriculturally. Proper formulation is dependent upon the route of administration chosen.

I claim:

1. A biocidal composition comprising 0.00663 weight percent of a positive charge enhancing additive, 0.00663 weight percent of a carrier, and 0.00663 weight percent of an active biocidal component wherein a positive charge of the positive charge enhancing additive in combination with the carrier facilitates entry of the active biocidal component into a cellular wall of a fungal spore, virus and microorganism.

2. The biocidal composition of claim 1 wherein the positive charge enhancing additive is potassium sorbate.

3. The biocidal composition of claim 1 wherein the biocidal composition is a suspension and further comprises an emulsifier.

4. The biocidal composition of claim 1 wherein the carrier is cellulose.

5. The biocidal composition of claim 1 wherein the active biocidal component is wax.

6. The biocidal composition of claim 1 wherein the biocidal composition is a suspension and further comprises catalyst activated fluorine and chlorine free water.

7. A biocidal composition in the form of a suspension comprising distilled water and a biocidally effective mixture formed of equal parts of potassium sorbate, lecithin, cellulose, and wax.

8. The biocidal composition of claim 7 wherein the distilled water comprises mineralized distilled water.

9. The biocidal composition of claim 7 wherein the distilled water comprises a solution formed of catalyst activated water and distilled mineralized water wherein the solution contains at least 15% catalyst activated water.

10. The biocidal composition of claim 9 wherein the biocidally effective mixture is mixed with catalyst activated water (CAW) such that the weight ratio of potassium sorbate to CAW is 0.0441%; the weight ratio of lecithin to CAW is 0.0441%; the weight ratio of cellulose to CAW is 0.0441%; and the weight ratio of wax to CAW is 0.0441%.

11. A mold inhibiting composition comprising a suspension formed of cellulose, distilled water and microdispersed wax.

12. The mold inhibiting composition of claim 11 wherein the mold inhibiting composition further comprises a positive charge enhancing additive.

13. The mold inhibiting composition of claim 12 wherein the positive charge enhancing additive is potassium sorbate.

14. The mold inhibiting composition of claim 11 wherein the mold inhibiting composition further comprises an emulsifier.

15. A method of inhibiting gram negative bacteria, viral, mold and fungal growth, comprising treatment of a surface with a biocidal composition comprising a suspension of distilled water and a biocidally effective mixture formed of equal parts a positive charge enhancing additive, an emulsifier, a carrier, and an active biocidal component.

16. The method of inhibiting gram negative bacteria, viral, mold and fungal growth of claim 15 wherein the biocidally effective mixture comprises equal parts of potassium sorbate, lecithin, cellulose, and wax.

17. A method of inhibiting the growth of microorganisms, fungal spores and viruses by using cellulose as a carrier for a wax to be ingested by the microorganism, fungal spore or virus such that the ingested wax encapsulates the microorganism, fungal spore or virus, thereby effectively suffocating the fungal spore, virus or microorganism.

18. A method of inhibiting the growth of microorganisms, fungal spores and viruses, comprising the steps of:
combining a biocidally effective mixture containing a positive charge and a wax with a food component of the microorganism, fungal spore or virus, wherein the microorganism, fungal spore or virus has a negative charge;
attracting the microorganism, fungal spore or virus to the positive charge; and
causing the microorganism, fungal spore or virus to ingest the biocidally effective mixture, wherein the positive charge in combination with the food component facilitates entry of the biocidally effective mixture into a digestive canal of the fungal spore, virus or microorganism, thereby effectively suffocating the fungal spore, virus or microorganism when the wax blocks an air or digestive action pathway of the fungal spore, virus or microorganism.

19. The method of inhibiting the growth of microorganisms, fungal spores and viruses of claim 18 wherein the positive charge is a positive ionic charge of potassium sorbate.

20. The method of inhibiting the growth of microorganisms, fungal spores and viruses of claim 18 wherein the food component comprises cellulose.
